(19) United States
(12) Patent Application Publication
(10) Pub. No.: US 2017/0331818 A1
(43) Pub. Date: Nov. 16, 2017

(54) SYSTEMS AND METHODS FOR LOCATION-RESTRICTING ONE-TIME PASSCODES

(71) Applicant: Symantec Corporation, Mountain View, CA (US)

(72) Inventors: Mohammed Abdul Kader, Kanchipuram (IN); IIya Sokolov, Boston, MA (US); Michael Shavell, Merrimack, NH (US); Jose Reyes, Los Angeles, CA (US)

(21) Appl. No.: 15/154,253

(22) Filed: May 13, 2016

(51) Int. Cl. H04L 29/06; H04W 12/06; H04W 48/04

(52) U.S. Cl. CPC H04L 63/0838; H04L 67/42; H04W 12/06; H04L 63/102; H04L 63/107; H04W 48/04

(57) ABSTRACT

The disclosed computer-implemented method for location-restricting one-time passcodes may include (1) receiving, from a client, an authentication request for a user account, (2) receiving, in association with the authentication request, a one-time passcode that incorporates an originating location for the authentication request, (3) obtaining a location identifier indicating the location of the client, (4) determining that the location identifier indicates a location equivalent to the originating location, and (5) determining, at least in part in response to determining that the location identifier indicates a location equivalent to the originating location, to authenticate the client to the user account. Various other methods, systems, and computer-readable media are also disclosed.

### BACKGROUND

To increase the security of personal information stored within online accounts, online services are increasingly choosing to offer or require that users complete Multi-Factor Authentication (MFA) schemes to access or sign into their accounts. MFA schemes may involve entering a traditional username and password combination, and in addition providing a one-time passcode (OTP) (e.g., a cryptographic authentication code, which may be generated by an additional device owned by the user). By adding multiple layers of security, MFA schemes may decrease the likelihood that a malicious user or hacker can access a private account.

Some online services attempt to enhance the security of one-time passcodes by requiring them to be used within a short period of time, typically within a few minutes. However, the speed of network communication still makes it is possible for an attacker to intercept the OTP (for example, by using a malicious browser plugin) and use it within the time limit. Accordingly, the instant disclosure identifies and addresses a need for additional and improved systems and methods for location-restricting one-time passcodes.

### SUMMARY

As will be described in greater detail below, the instant disclosure describes various systems and methods for location-restricting one-time passcodes by incorporating an originating location into a one-time passcode. The disclosed systems may obtain a location identifier indicating the location of the client requesting authentication, compare the location indicated by the location identifier with the originating location, and determine whether to authenticate the client based at least in part on the location identifier matching the originating location. By determining that the authentication request originated at the same location as the client requesting authentication, the disclosed systems may prevent an attacker from intercepting the one-time passcode and using it to authenticate from another location.

In one example, a computer-implemented method for location restricting one-time passcodes may include (1) receiving, from a client, an authentication request for a user account, (2) receiving, in association with the authentication request, a one-time passcode that incorporates an originating location for the authentication request, (3) obtaining a location identifier indicating the location of the client, (4) determining that the location identifier indicates a location equivalent to the originating location, and (5) determining, at least in part in response to determining that the location identifier indicates a location equivalent to the originating location, to authenticate the client to the user account.

In some examples, the computer-implemented method may further include requesting a device associated with the user account to generate the one-time passcode. In one embodiment, the one-time passcode is received from the associated device. In one embodiment, the one-time passcode is received from the client. In some examples, receiving the one-time passcode may include providing the location identifier to a communication service provider capable of identifying a location for the associated device and requesting the communication service provider to provide the one-time passcode when the location identifier indicates a location equivalent to that of the associated device.

In some examples, determining that the location identifier indicates a location equivalent to the originating location may include determining that the location identifier indicates a location within a threshold distance of the originating location. In one embodiment, the threshold distance is based at least in part on the technique used to obtain at least one of the location identifier and the originating location. In one embodiment, the one-time passcode may include a timestamp.

In one embodiment, a system for implementing the above-described method may include several modules stored in memory, such as (1) a communication module that receives, from a client, an authentication request for a user account, (2) an origination module that receives, in association with the authentication request, a one-time passcode that incorporates an originating location for the authentication request, (3) a location module that obtains a location identifier indicating the location of the client, (4) a comparison module that determines that the location identifier indicates a location equivalent to the originating location, and/or (5) an authentication module that determines, at least in part in response to determining that the location identifier indicates a location equivalent to the originating location, to authenticate the client to the user account. The system may also include at least one physical processor configured to execute the communication module, the origination module, the location module, the comparison module, and the authentication module.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) receive, from a client, an authentication request for a user account, (2) receive, in association with the authentication request, a one-time passcode that incorporates an originating location for the authentication request, (3) obtain a location identifier indicating the location of the client, (4) determine that the location identifier indicates a location equivalent to the originating location, and (5) determine, at least in part in response to determining that the location identifier indicates a location equivalent to the originating location, to authenticate the client to the user account.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of illustrative embodiments and are a part of the specification. Together with the following description, these drawings demonstrate and explain various principles of the instant disclosure.

FIG. 1 is a block diagram of an illustrative system for location-restricting one-time passcodes.

FIG. 2 is a block diagram of an additional illustrative system for location-restricting one-time passcodes.

FIG. 3 is a flow diagram of an illustrative method for location-restricting one-time passcodes.

FIG. 4 is a block diagram of an illustrative computing system for location-restricting one-time passcodes.

FIG. 5 is a block diagram of an illustrative computing system for location-restricting one-time passcodes.

FIG. 6 is a block diagram of an illustrative computing system capable of implementing one or more of the embodiments described and/or illustrated herein.

FIG. 7 is a block diagram of an illustrative computing network capable of implementing one or more of the embodiments described and/or illustrated herein.

Throughout the drawings, identical reference characters and descriptions indicate similar, but not necessarily identical, elements. While the illustrative embodiments described herein are susceptible to various modifications and alternative forms, specific embodiments have been shown by way of example in the drawings and will be described in detail herein. However, the illustrative embodiments described herein are not intended to be limited to the particular forms disclosed. Rather, the instant disclosure covers all modifications, equivalents, and alternatives falling within the scope of the appended claims.

### DETAILED DESCRIPTION OF ILLUSTRATIVE EMBODIMENTS

The present disclosure is generally directed to systems and methods for location-restricting one-time passcodes. As will be explained in greater detail below, the systems and methods described herein may determine whether a one-time passcode associated with an authentication request originated at the same location as the client attempting to authenticate. By location-restricting one-time passcodes, the systems and methods described herein may prevent an attacker from using a stolen one-time passcode to authenticate to a user's account. The systems and methods described herein may also incorporate a timestamp into a one-time passcode to restrict both the time and place the passcode may be used.

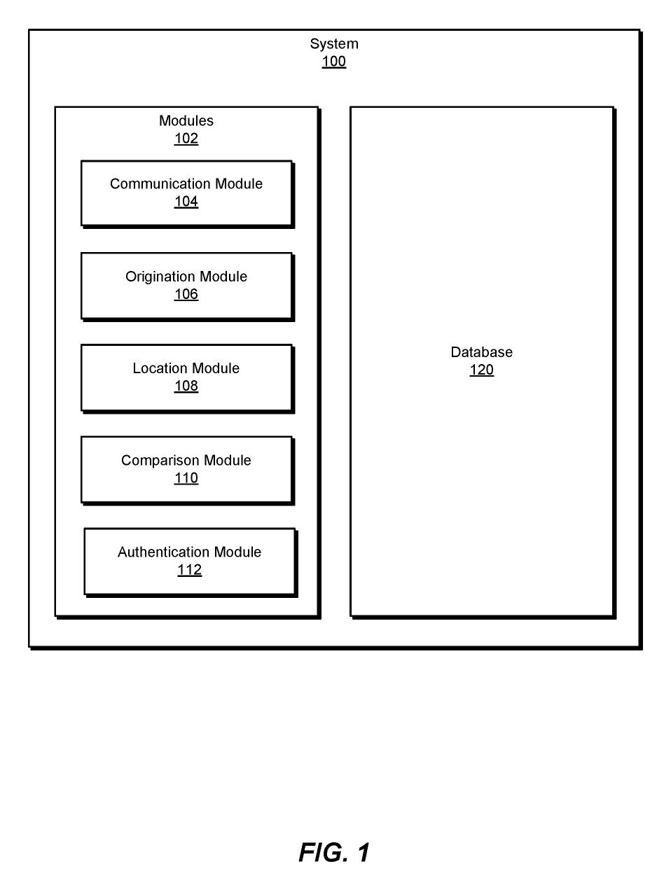

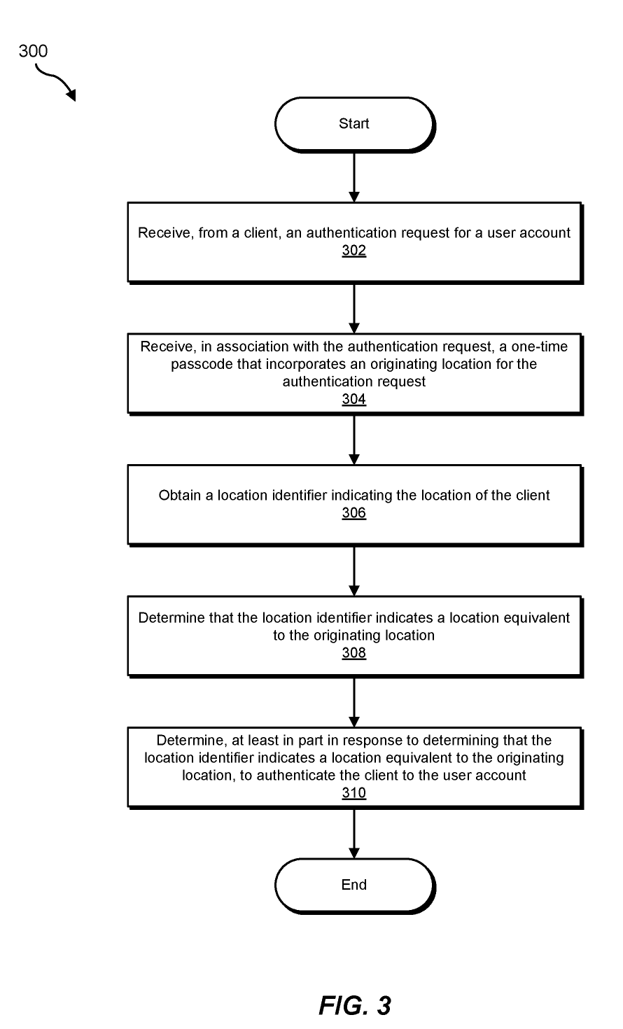

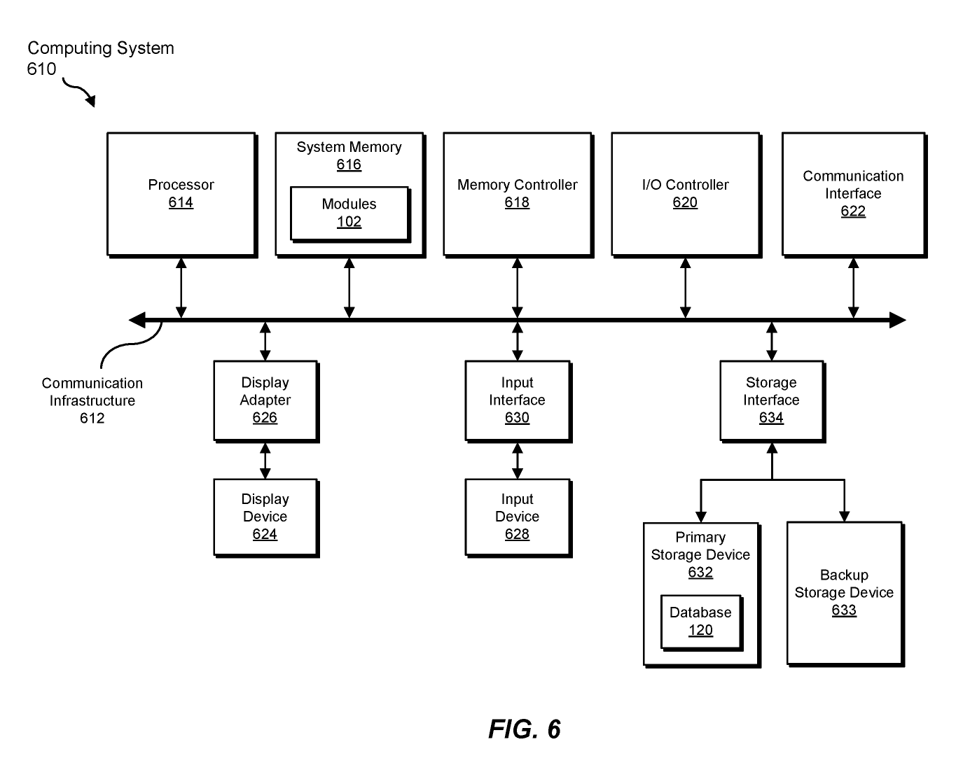

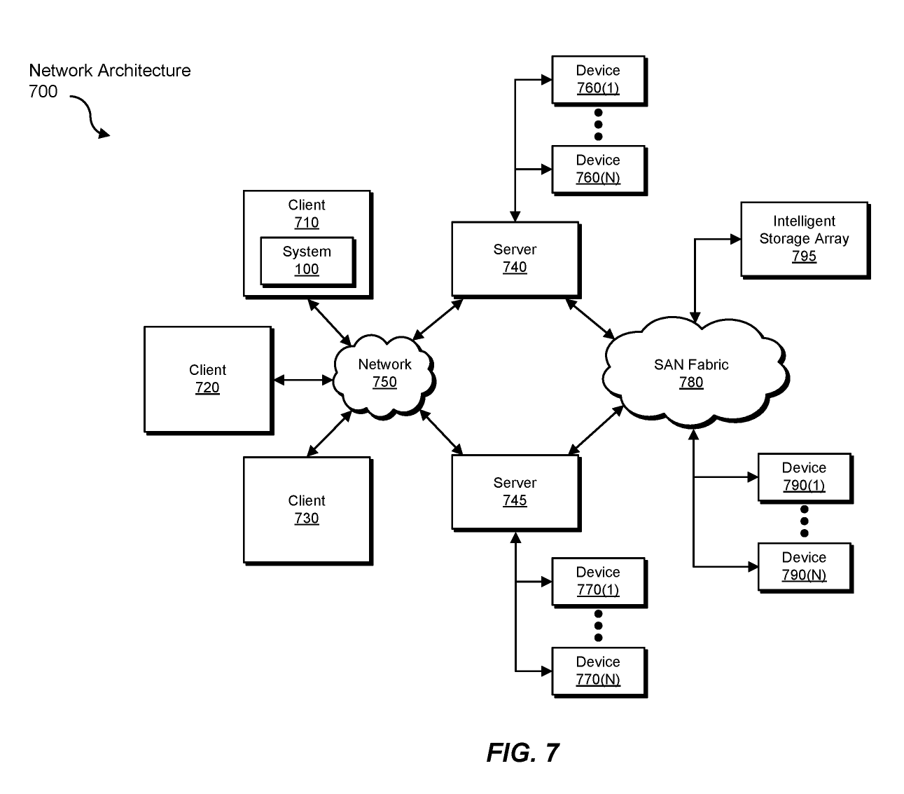

The following will provide, with reference to FIGS. 1, 2, 4, and 5, detailed descriptions of illustrative systems for location-restricting one-time passcodes. Detailed descriptions of corresponding computer-implemented methods will also be provided in connection with FIG. 3. In addition, detailed descriptions of an illustrative computing system and network architecture capable of implementing one or more of the embodiments described herein will be provided in connection with FIGS. 6 and 7, respectively.

FIG. 1 is a block diagram of illustrative system 100 for location restricting one-time passcodes. As illustrated in this figure, illustrative system 100 may include one or more modules 102 for performing one or more tasks. For example, and as will be explained in greater detail below, illustrative system 100 may include a communication module 104 that receives, from a client, an authentication request for a user account. Illustrative system 100 may additionally include an origination module 106 that receives, in association with the authentication request, a one-time passcode that incorporates an originating location for the authentication request. Illustrative system 100 may also include a location module 108 that obtains a location identifier indicating the location of the client. Illustrative system 100 may additionally include a comparison module 110 that determines that the location identifier indicates a location equivalent to the originating location. Illustrative system 100 may also include an authentication module 112 that determines, at least in part in response to determining that the location identifier indicates a location equivalent to the originating location, to authenticate the client to the user account. Although illustrated as separate elements, one or more of modules 102 in FIG. 1 may represent portions of a single module or application.

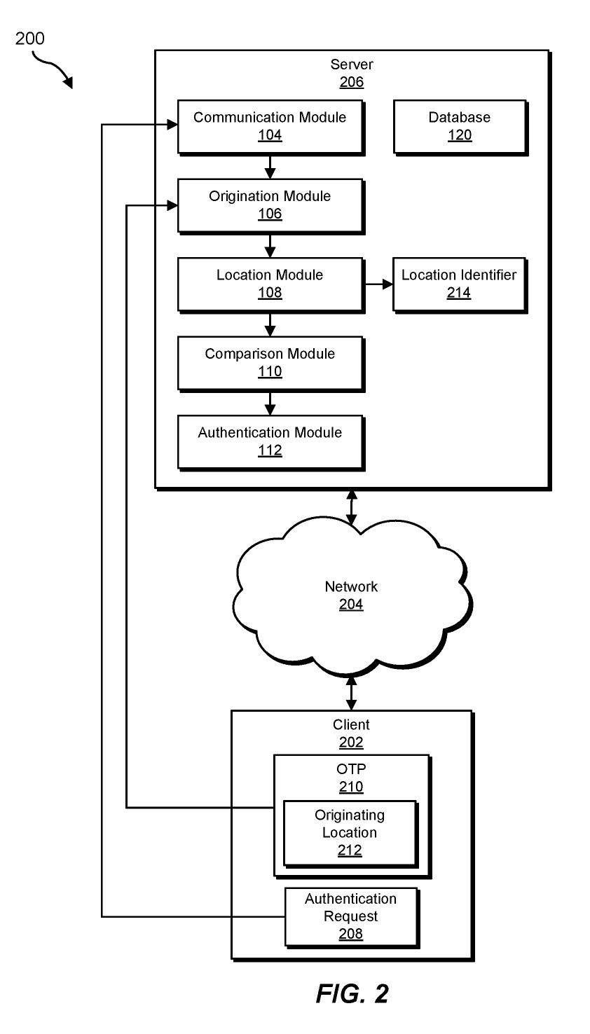

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent software modules stored and configured to run on one or more computing devices, such as the devices illustrated in FIG. 2 (e.g., client 202 and/or server 206), computing system 610 in FIG. 6, and/or portions of illustrative network architecture 700 in FIG. 7. One or more of modules 102 in FIG. 1 may also represent all or portions of one or more special-purpose computers configured to perform one or more tasks.

As illustrated in FIG. 1, illustrative system 100 may also include one or more databases, such as database 120. In one example, database 120 may be configured to store user account information, and/or authentication credentials. Database 120 may represent portions of a single database or computing device or a plurality of databases or computing devices. For example, database 120 may represent a portion of server 206 in FIG. 2, computing system 610 in FIG. 6, and/or portions of illustrative network architecture 700 in FIG. 7. Alternatively, database 120 in FIG. 1 may represent one or more physically separate devices capable of being accessed by a computing device, such as server 206 in FIG. 2, computing system 610 in FIG. 6, and/or portions of illustrative network architecture 700 in FIG. 7.

Illustrative system 100 in FIG. 1 may be implemented in a variety of ways. For example, all or a portion of illustrative system 100 may represent portions of illustrative system 200 in FIG. 2. As shown in FIG. 2, system 200 may include a client 202 in communication with a server 206 via a network 204. In one example, client 202 may be programmed with one or more of modules 102 and/or may store all or a portion of the data in database 120. Additionally or alternatively, server 206 may be programmed with one or more of modules 102 and/or may store all or a portion of the data in database 120.

In one embodiment, one or more of modules 102 from FIG. 1 may, when executed by at least one processor of client 202 and/or server 206, enable client 202 and/or server 206 to location-restrict one-time passcodes. For example, and as will be described in greater detail below, one or more of modules 102 may cause client 202 and/or server 206 to location-restrict one-time passcodes. For example, and as will be described in greater detail below, communication module 104 may receive, from a client 202, an authentication request 208 for a user account. Communication module 104 may receive, in association with authentication request 208, a one-time passcode 210 that incorporates an originating location 212 for authentication request 208. Location module 108 may obtain a location identifier 214 indicating the location of client 202. Comparison module 110 may determine that location identifier 214 indicates a location equivalent to originating location 212. Authentication module 112 may determine, at least in part in response to determining that location identifier 214 indicates a location equivalent to originating location 212, to authenticate client 202 to the user account.

Client 202 generally represents any type or form of computing device capable of reading computer-executable instructions. Examples of client 202 include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, illustrative computing system 610 in FIG. 6, or any other suitable computing device.

Server 206 generally represents any type or form of computing device that is capable of receiving, comparing, and storing data. Examples of server 206 include, without limitation, application servers and database servers configured to provide various database services and/or run certain software applications.

Network 204 generally represents any medium or architecture capable of facilitating communication or data transfer. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), illustrative network architecture 700 in FIG. 7, or the like. Network 204 may facilitate communication or data transfer using wireless or wired connections. In one embodiment, network 204 may facilitate communication between client 202 and server 206.

FIG. 3 is a flow diagram of an illustrative computer-implemented method 300 for location-restricting one-time passcodes. The steps shown in FIG. 3 may be performed by any suitable computer-executable code and/or computing system. In some embodiments, the steps shown in FIG. 3 may be performed by one or more of the components of system 100 in FIG. 1, system 200 in FIG. 2, computing system 610 in FIG. 6, and/or portions of illustrative network architecture 700 in FIG. 7.

As illustrated in FIG. 3, at step 302, one or more of the systems described herein may receive, from a client, an authentication request for a user account. For example, communication module 104 may, as part of server 206 in FIG. 2, receive, from client 202, authentication request 208 for a user account.

Communication module 104 may receive an authentication request in a variety of ways. For example, authentication request 208 may represent an attempt by a user to authenticate to an online service executing on server 206 from a browser executing on a laptop or desktop computer. In another example, authentication request 208 may represent an attempt by a user to authenticate to the online service from an application executing on a smart phone. Communication module 104 may receive authentication request via hypertext transfer protocol secure (HTTPS).

At step 304, one or more of the systems described herein may receive, in association with the authentication request, a one-time passcode that incorporates an originating location for the authentication request. For example, origination module 106 may, as part of server 206 in FIG. 2, receive, in association with authentication request 208, one-time passcode 210 that incorporates originating location 212 for authentication request 208.

The term “one-time passcode,” (OTP) as used herein, generally refers to a passcode that is valid for only one login session. One-time passcodes may be generated in a variety of ways, such as performing a mathematical calculation on a previous passcode and shared secret. In some examples, an OTP may be generated by a small device called a “security token” or “authentication token” or by an application executing on a smart phone. In some examples, an OTP may be randomly generated on a server and delivered to a device associated with the user account.

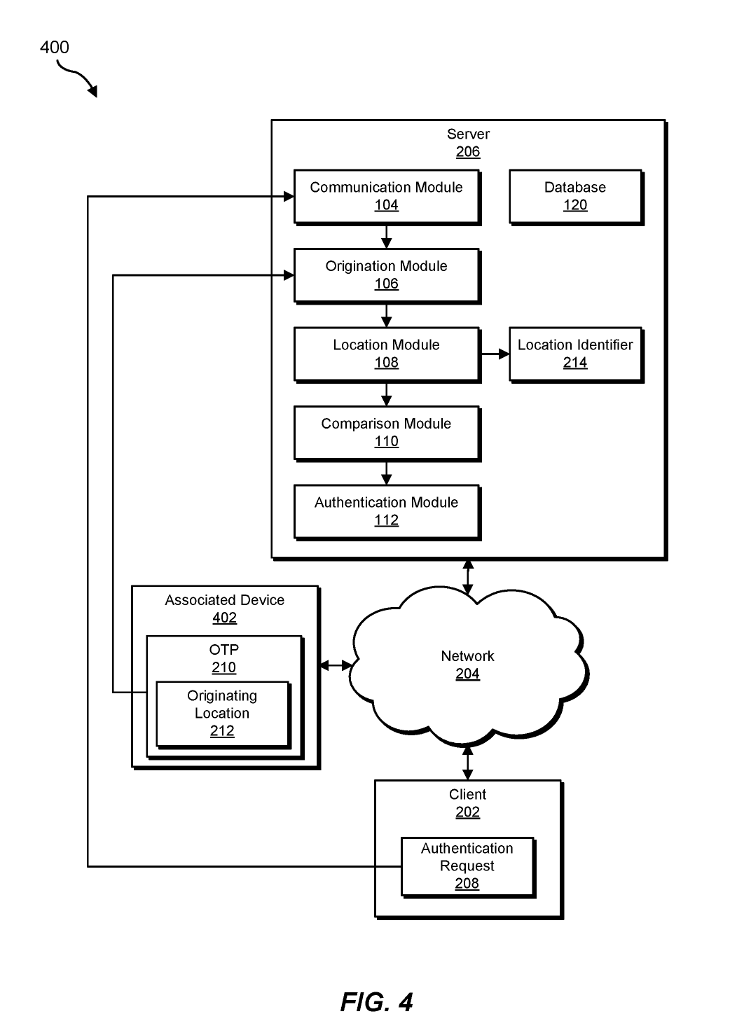

One-time passcode 210 may incorporate originating location 212 for authentication request 208 in a variety of ways. For example, client 202 may obtain its location from a GPS device or from geolocation of its IP address and generate one-time passcode 210 incorporating originating location 212. As will be described in greater detail below in connection with FIG. 4, a device associated with the user account, such as a smartphone or security token, may generate one-time passcode 210, with originating location 212 based on the location of the associated device.

In one embodiment, the one-time passcode may include a timestamp to restrict the period of time for which the one-time passcode may be used, in addition to the originating location. For example, a security token or smart phone application may generate a one-time passcode by applying a mathematical algorithm to a shared secret, the originating location, and a timestamp representing the time at which the one-time passcode was generated, rounded to a specific number of minutes or seconds. The service receiving the one-time passcode may apply the same algorithm to the shared secret, a location identifier indicating the originating location, and a timestamp representing the time the one-time passcode was received, rounded by the same factor. By comparing the two calculated values, the service may verify (1) that the authenticating client possesses the shared secret, (2) that the one-time passcode was generated at the same location the authentication request originated, and (3) that the one-time passcode was generated within the period of time represented by the round-off factor. By generating a one-time passcode that includes both an originating location and a timestamp, the systems and methods described herein may restrict use of a one-time passcode by both location and time.

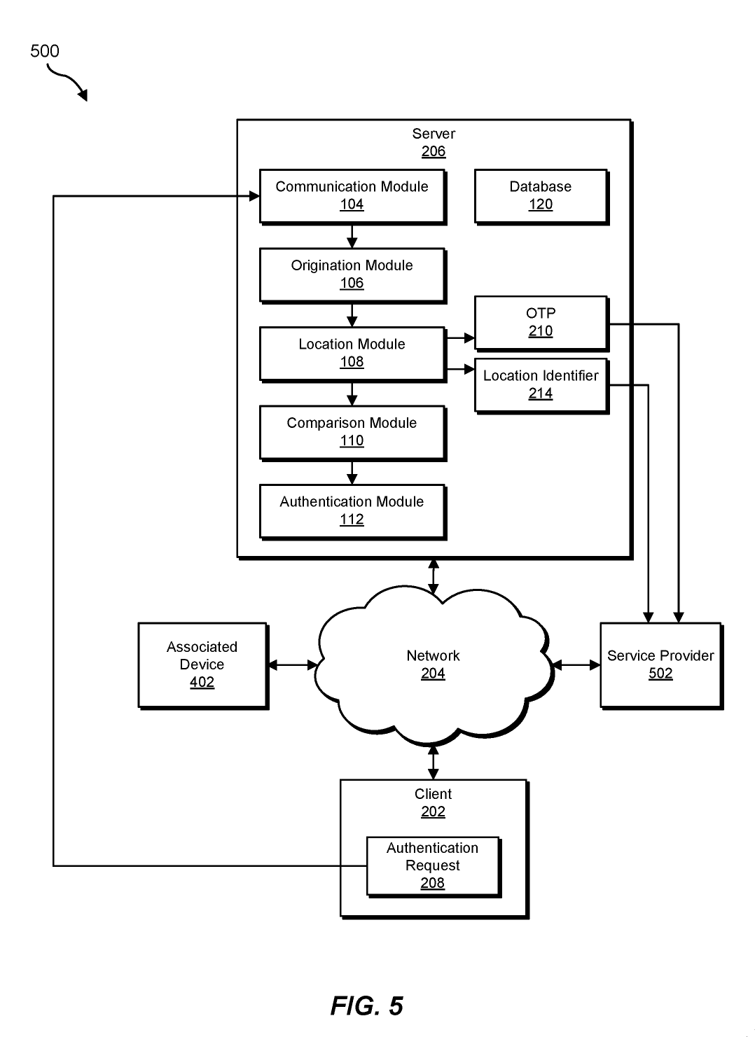

Origination module 106 may receive a one-time passcode in a variety of ways. For example, origination module 106 may receive one-time passcode 210 from client 202 via HTTPS, along with other authentication credentials, such as a user name or biometric data. In some examples, and as will be described in greater detail below in connection with FIG. 5, origination module 106 may receive one-time passcode 210 from a service provider, such as a wireless communication service or authentication service. In some examples, origination module 106 may receive the one-time passcode from a device associated with the user account, such as a security token or smart phone.

FIG. 4 is a block diagram of an illustrative system 400 for location-restricting one-time passcodes that includes a device associated with the user account that provides the one-time passcode. Illustrative system 400 may include elements of illustrative system 200 in FIG. 2, such as client 202, network 240, and server 206. Additionally, illustrative system 400 may include associated device 402, which may be associated with the user account to which authentication request 208 is attempting to authenticate. Associated device 402 may generate one-time passcode 210 that includes originating location 212. In one example, associated device 402 may be a smartphone that includes an application for generating one-time passcode 210. In another example, associated device 402 may be a security token.

Associated device 402 may obtain originating location 212 in a variety of ways. For example, associated device 402 may include an integrated GPS unit. In other examples, associated device 402 may obtain originating location 212 via a communication medium used to transmit one-time passcode 210 to origination module 106. For example, associated device 402 may communicate via a Wi-Fi connection or wireless data network, such as a 3G or 4G network, and associated device 402 may obtain originating location 212 by IP geolocation or cell tower triangulation.

At step 306, one or more of the systems described herein may obtain a location identifier indicating the location of the client. For example, location module 108 may, as part of client 202 in FIG. 2, obtain location identifier 214 indicating the location of client 202.

Location module 108 may obtain a location identifier indicating the location of the client in a variety of ways. For example, location module 108 may obtain from authentication request 208 the IP address from which client 202 transmitted authentication request 208. Location module 108 may use IP geolocation to obtain the approximate location of client 202. In other examples, location module 108 may apply various techniques to obtain the location of client 202, depending on features of client 202 and/or the communication media accessible to client 202. For example, client 202 may be a smartphone and location module 108 may receive location identifier 214 from a client agent executing on the smartphone that obtains its location from a GPS unit or by cell tower triangulation. In some examples, location module 108 may receive one-time passcode 210 via an SMS message or voice call and location module 108 may obtain location identifier 214 from telephony data associated with the transmission. In situation where a high level of security is desirable, location module 108 may use multiple techniques to identify the location of client 202 and/or use a different technique that that used to obtain originating location 212.

In some examples, systems and methods described herein may receive the one-time passcode by providing the one-time passcode (which may be a randomly generated value) and the location identifier to a communication service provider capable of identifying a location for the associated device. Systems and methods described herein may then request the communication service provider to provide the one-time passcode when the location identifier indicates a location equivalent to that of the associated device.

FIG. 5 is a block diagram of an illustrative system 500 for location-restricting one-time passcodes that includes a device associated with the user account and a service provider capable of identifying the location of the associated device. Illustrative system 500 may include elements of illustrative system 200 in FIG. 2, such as client 202, network 240, and server 206. Additionally, illustrative system 500 may include associated device 402, shown in illustrative system 400 in FIG. 4. Illustrative system 500 may also include service provider 502, which may be capable of identifying the location of associated device 402. In one example, service provider 502 may be a mobile communication service provider and associated device 402 may be a smartphone. In another example, service provider 502 may be an authentication service provider and associated device 402 may be a security token capable of communicating with service provider 502. In response to receiving authentication request 208, location module 108 may provide one-time passcode 210 and location identifier 214 to service provider 502. If service provider 502 determines that associated device is located at the location indicated by location identifier 214, service provider 502 may provide one-time passcode 210 to associated device 402. Service provider 502 may, for example, deliver one-time passcode 210 via a voice call or SMS message. Service provider 502 may then direct associated device 402 to transmit one-time passcode 210 to origination module 106. In another example, service provider 502 may receive one-time passcode 210 and transmit it to origination module 106. Using service provider 502 to independently identify the location of associated device 402 may increase the confidence level that location identifier 214 accurately represents the location of client 202.

At step 308, one or more of the systems described herein may determine that the location identifier indicates a location equivalent to the originating location. For example, comparison module 110 may, as part of client 202 in FIG. 2, determine that location identifier 214 indicates a location equivalent to originating location 212.

Comparison module 110 may determine that the location identifier indicates a location equivalent to the originating location in a variety of ways. For example, comparison module 110 may determine that client 202, which initiated the authentication process by transmitting authentication request 208, and a smartphone associated with the user account, represented in FIG. 4 as associated device 402, are connected to the same Wi-Fi network, and are both within range of other Wi-Fi networks. Comparison module 110 may also determine that authentication request 208 and one-time passcode 210 originated from the same IP address, indicating that both client 202 and associated device are connected to the same local network.

In some examples, comparison module 110 may determine that the location identifier indicates a location equivalent to the originating location by determining that the location identifier indicates a location within a threshold distance of the originating location. For example, origination module 106 may determine that both originating location 212, which associated device 402, a smartphone, obtained from its GPS unit and included in one-time passcode 210, and location identifier 214, which location module 108 obtained by IP geolocation of the IP address from which client 202 transmitted authentication request 208, indicate a location within a radius of a few miles of the home address of the owner of the user account identified in authentication request 208.

In one embodiment, the threshold distance is based at least in part on the technique used to obtain at least one of the location identifier and the originating location. In the above example, a GPS location may be accurate within a few feet, while geolocation by IP address may be much less accurate, perhaps identifying only the city or state associated with the IP address. In some examples, comparison module 110 may set a small threshold distance when accurate location techniques are used to obtain both the location identifier and the originating location. In some examples, comparison module 110 may reduce the threshold distance when an administrator or the owner of the user account indicates that authentication should be permitted only when the location of client 202 can be determined with a high degree of accuracy.

At step 310, one or more of the systems described herein may determine, at least in part in response to determining that the location identifier indicates a location equivalent to the originating location, to authenticate the client to the user account. For example, authentication module 112 may, as part of client 202 in FIG. 2, determine, at least in part in response to determining that location identifier 214 indicates a location equivalent to originating location 212, to authenticate client 202 to the user account.

Authentication module 112 may determine to authenticate the client to the user account based on various factors. For example, authentication module 112 may determine to authenticate the client to the user account based solely on location identifier 214 indicating a location equivalent to originating location 212, or the two locations indicating that the user is attempting to authenticate from an expected location. This approach may provide greater convenience to a user than requiring the user to provide additional authentication factors, while maintaining a minimal level of security for the user account. In other examples, authentication module 112 may determine to authenticate the client to the user account based on additional factors, such as the user providing a previously chosen password, answers to one or more challenge questions, or biometric data. In some examples, authentication module 112 may base the set of authentication factors necessary to authenticate the client in part on a desired level of security for the user account, as indicated by an administrator or owner of the account.

As described in greater detail above, the systems and methods described herein may location-restrict one-time passcodes by determining whether an originating location for an authentication request is equivalent to a location identifier that indicates the location of the client from which the authentication request was submitted, or the location of a device associated with the user account. The systems and methods described herein may obtain the one-time password from the authenticating client, a device associated with the user account, or a service provider, such as a wireless communication service provider or authentication service provider. By location-restricting one-time passcodes, the systems and methods described herein may protect user accounts from attacks that attempt to intercept passcodes and use them from another location.

FIG. 6 is a block diagram of an illustrative computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the illustrative embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In certain embodiments, illustrative computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

Communication interface 622 broadly represents any type or form of communication device or adapter capable of facilitating communication between illustrative computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

As illustrated in FIG. 6, computing system 610 may also include at least one display device 624 coupled to communication infrastructure 612 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, illustrative computing system 610 may also include at least one input device 628 coupled to communication infrastructure 612 via an input interface 630. Input device 628 generally represents any type or form of input device capable of providing input, either computer or human generated, to illustrative computing system 610. Examples of input device 628 include, without limitation, a keyboard, a pointing device, a speech recognition device, or any other input device.

As illustrated in FIG. 6, illustrative computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, database 120 from FIG. 1 may be stored in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the illustrative embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the illustrative embodiments described and/or illustrated herein. Additionally or alternatively, one or more of the illustrative embodiments described and/or illustrated herein may be implemented in firmware and/or hardware. For example, computing system 610 may be configured as an Application Specific Integrated Circuit (ASIC) adapted to implement one or more of the illustrative embodiments disclosed herein.

FIG. 7 is a block diagram of an illustrative network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the instant disclosure.

Client systems 710, 720, and 730 generally represent any type or form of computing device or system, such as illustrative computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to illustrative computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the illustrative embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the illustrative embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an illustrative method for location-restricting one-time passcodes.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered illustrative in nature since many other architectures can be implemented to achieve the same functionality.

In some examples, all or a portion of illustrative system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of illustrative system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of illustrative system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of illustrative system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of illustrative system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of illustrative system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of illustrative system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various illustrative methods described and/or illustrated herein may also omit one or more of the steps described or illustrated herein or include additional steps in addition to those disclosed.

While various embodiments have been described and/or illustrated herein in the context of fully functional computing systems, one or more of these illustrative embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the illustrative embodiments disclosed herein.

In addition, one or more of the modules described herein may transform data, physical devices, and/or representations of physical devices from one form to another. For example, one or more of the modules recited herein may receive authentication requests and one-time passcodes to be transformed, transform the authentication requests and one-time passcodes, output a result of the transformation to identify the location of an authenticating client, use the result of the transformation to determine whether the authentication request originated from the client's location, and store the result of the transformation to determine whether to authenticate the client. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the illustrative embodiments disclosed herein. This illustrative description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for location-restricting one-time passcodes, at least a portion of the method being performed by a computing device comprising at least one processor, the method comprising:
receiving, from a client, an authentication request for a user account;
receiving, in association with the authentication request, a one-time passcode that incorporates an originating location for the authentication request;
obtaining a location identifier indicating the location of the client;
determining that the location identifier indicates a location equivalent to the originating location;
determining, at least in part in response to determining that the location identifier indicates a location equivalent to the originating location, to authenticate the client to the user account.

2. The computer-implemented method of claim 1, further comprising requesting a device associated with the user account to generate the one-time passcode.

3. The computer-implemented method of claim 2, wherein the one-time passcode is received from the associated device.

4. The computer-implemented method of claim 2, wherein the one-time passcode is received from the client.

5. The computer-implemented method of claim 2, wherein receiving the one-time passcode comprises:
providing the location identifier to a communication service provider capable of identifying a location for the associated device;
requesting the communication service provider to provide the one-time passcode when the location identifier indicates a location equivalent to that of the associated device.

6. The computer-implemented method of claim 1, wherein determining that the location identifier indicates a location equivalent to the originating location comprises determining that the location identifier indicates a location within a threshold distance of the originating location.

7. The computer-implemented method of claim 6, wherein the threshold distance is based at least in part on a technique used to obtain at least one of the location identifier and the originating location.

8. The computer-implemented method of claim 1, wherein the one-time passcode comprises a timestamp.

9. A system for location restricting one-time passcodes, the system comprising:
a communication module, stored in memory, that receives, from a client, an authentication request for a user account;
an origination module, stored in memory, that receives, in association with the authentication request, a one-time passcode that incorporates an originating location for the authentication request;
a location module, stored in memory, that obtains a location identifier indicating the location of the client;
a comparison module, stored in memory, that determines that the location identifier indicates a location equivalent to the originating location;
an authentication module, stored in memory, that determines, at least in part in response to determining that the location identifier indicates a location equivalent to the originating location, to authenticate the client to the user account;
at least one physical processor configured to execute the communication module, the origination module, the location module, the comparison module, and the authentication module.

10. The system of claim 9, wherein the origination module requests a device associated with the user account to generate the one-time passcode.

11. The system of claim 10, wherein the origination module receives the one-time passcode from the associated device.

12. The system of claim 10, wherein the origination module receives one-time passcode from the client.

13. The system of claim 10, wherein the origination module receives the one-time passcode by:
providing the location identifier to a communication service provider capable of identifying a location for the associated device;
requesting the communication service provider to provide the one-time passcode when the location identifier indicates a location equivalent to that of the associated device.

14. The system of claim 9, wherein the comparison module determines that the location identifier indicates a location equivalent to the originating location by determining that the location identifier indicates a location within a threshold distance of the originating location.

15. The system of claim 14, wherein the threshold distance is based at least in part on a technique used to obtain at least one of the location identifier and the originating location.

16. The system of claim 9, wherein the one-time passcode comprises a timestamp.

17. A non-transitory computer-readable medium comprising one or more computer-readable instructions that, when executed by at least one processor of a computing device, cause the computing device to:
receive, from a client, an authentication request for a user account;
receive, in association with the authentication request, a one-time passcode that incorporates an originating location for the authentication request;
obtain a location identifier indicating the location of the client;
determine that the location identifier indicates a location equivalent to the originating location;
determine, at least in part in response to determining that the location identifier indicates a location equivalent to the originating location, to authenticate the client to the user account.

18. The non-transitory computer-readable medium of claim 17, wherein the one or more computer-readable instructions cause the computing device to request a device associated with the user account to generate the one-time passcode.

19. The non-transitory computer-readable medium of claim 18, wherein the one or more computer-readable instructions cause the computing device to receive the one-time passcode from the associated device.

20. The non-transitory computer-readable medium of claim 18, wherein the one or more computer-readable instructions cause the computing device to receive the one-time passcode from the client.
